(19) United States
(12) Patent Application Publication
(10) Pub. No.: US 2013/0201084 A1
(43) Pub. Date: Aug. 8, 2013

(54) NAKED EYE TYPE AND GLASSES TYPE SWITCHABLE STEREOSCOPIC DISPLAY DEVICE

(71) Applicant: WINTEK CORPORATION, Taichung City (TW)

(72) Inventors: Wen-Chun Wang, Taichung City (TW); Wei-Chou Chen, Hsinchu City (TW); Chong-Yang Fang, Taichung City (TW); Tsung-Hsien Lin, Taichung City (TW); Tsung-Yen Hsieh, Taichung City (TW)

(73) Assignee: WINTEK CORPORATION, Taichung City (TW)

(21) Appl. No.: 13/760,003

(22) Filed: Feb. 5, 2013

(30) Foreign Application Priority Data
Feb. 7, 2012 (TW) 101103945

(51) Int. Cl. G09G 5/14

(52) U.S. Cl. CPC G09G 5/14
USPC 345/32

(57) ABSTRACT

A naked eye type and glasses type switchable stereoscopic display device includes a display panel and a switching module. The display panel is used to provide first display information and second display information. The switching module is disposed on a side of a display surface of the display panel. The switching module forms a plurality of lenses to change directions of the first display information and the second display information under a naked eye type stereoscopic display mode, and the switching module provides a first phase retardation mode and a second phase retardation mode under a glasses type stereoscopic display mode. The first phase retardation mode corresponds to the first display information and renders the first display information a first polarization state, and the second phase retardation mode corresponds to the second display information and renders the second display information a second polarization state.

### BACKGROUND OF THE INVENTION

1. Field of the Invention

The present invention relates to a stereoscopic display device, and more particularly, to a stereoscopic display device capable of switching between a naked eye type stereoscopic display mode and a glasses type stereoscopic display mode.

2. Description of the Prior Art

Display related technologies have progressed in recent years; stereoscopic display technologies and related application have also developed flourishingly. The principle of the stereoscopic display technology includes respectively delivering different images to a left eye and a right eye of a viewer, giving the viewer a feeling of gradation and depth in the images, and generating the stereoscopic effect in the cerebrum of the viewer by analyzing and overlapping images separately received by the left eye and the right eye.

In general, the stereoscopic display technologies may be substantially divided into two major types, which are the glasses type and the naked eye type (auto stereoscopic type). The most popular glasses type stereoscopic display technologies include a shutter glasses type stereoscopic display technology and a polarized glasses type stereoscopic display technology. The display quality of the glasses type stereoscopic display is generally better than the display quality of the naked eye type stereoscopic display. However, the special glasses may still cause inconvenience when using the glasses type stereoscopic display device. Comparatively, the naked eye type stereoscopic display device may work without special glasses. In the general naked eye type stereoscopic display technologies, such as the lenticular lens type stereoscopic display technology, the irradiating directions of different display information are changed by lenses and guided toward the left eye or the right eye of the viewer. Accordingly, the viewing angle and the position of the viewer are limited in the naked eye type stereoscopic display technologies.

### SUMMARY OF THE INVENTION

It is one of the objectives of the present invention to provide a naked eye type and glasses type switchable stereoscopic display device. A switching module which is capable of forming lenses and providing phase retardation effects on light is disposed in front of a display panel, and the display device may be accordingly switched between a naked eye type stereoscopic display mode, a glasses type stereoscopic display mode, and a normal two-dimensional display mode.

To achieve the purposes described above, a preferred embodiment of the present invention provides a naked eye type and glasses type switchable stereoscopic display device. The naked eye type and glasses type switchable stereoscopic display device includes a display panel and a switching module. The display panel has a display surface. The display panel is used to provide first display information and second display information. The switching module is disposed on a side of the display surface of the display panel to receive the first display information and the second display information from the display panel. The switching module forms a plurality of lenses to change the directions of the first display information and the second display information under a naked eye type stereoscopic display mode, and the switching module provides a first phase retardation mode and a second phase retardation mode under a glasses type stereoscopic display mode. The first phase retardation mode corresponds to the first display information and renders the first display information a first polarization state, and the second phase retardation mode corresponds to the second display information and renders the second display information a second polarization state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a naked eye type and glasses type switchable stereoscopic display device according to a first preferred embodiment of the present invention.

FIG. 2 is a schematic diagram illustrating a display condition of the naked eye type and glasses type switchable stereoscopic display device under a glasses type stereoscopic display mode according to the first preferred embodiment of the present invention.

FIG. 3 is a schematic diagram illustrating a display condition of the naked eye type and glasses type switchable stereoscopic display device under a naked eye type stereoscopic display mode according to the first preferred embodiment of the present invention.

FIG. 4 is a schematic diagram illustrating an arrangement of lenses in the naked eye type and glasses type switchable stereoscopic display device according to the first preferred embodiment of the present invention.

FIG. 5 is a schematic diagram illustrating an arrangement of lenses in a naked eye type and glasses type switchable stereoscopic display device according to another preferred embodiment of the present invention.

FIG. 6 is a schematic diagram illustrating a naked eye type and glasses type switchable stereoscopic display device according to a second preferred embodiment of the present invention.

FIG. 7 is a schematic diagram illustrating a display condition of the naked eye type and glasses type switchable stereoscopic display device under a glasses type stereoscopic display mode according to the second preferred embodiment of the present invention.

FIG. 8 is a schematic diagram illustrating an operation of the naked eye type and glasses type switchable stereoscopic display device under the glasses type stereoscopic display mode according to the second preferred embodiment of the present invention.

FIG. 9 is a schematic diagram illustrating a display condition of the naked eye type and glasses type switchable stereoscopic display device under a naked eye type stereoscopic display mode according to the second preferred embodiment of the present invention.

FIG. 10 is a schematic diagram illustrating a display condition of the naked eye type and glasses type switchable stereoscopic display device under a glasses type stereoscopic display mode according to a third preferred embodiment of the present invention.

FIG. 11 is a schematic diagram illustrating a display condition of the naked eye type and glasses type switchable stereoscopic display device under a naked eye type stereoscopic display mode according to the third preferred embodiment of the present invention.

FIG. 12 is a schematic diagram illustrating a display condition of the naked eye type and glasses type switchable stereoscopic display device under a glasses type stereoscopic display mode according to a fourth preferred embodiment of the present invention.

FIG. 13 is a schematic diagram illustrating an operation of the naked eye type and glasses type switchable stereoscopic display device under the glasses type stereoscopic display mode according to the fourth preferred embodiment of the present invention.

### DETAILED DESCRIPTION

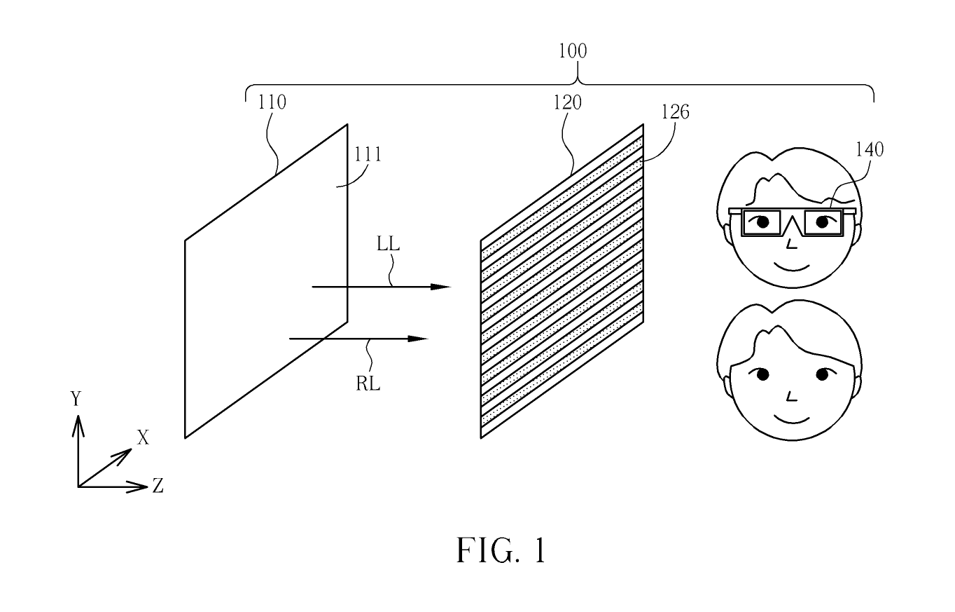

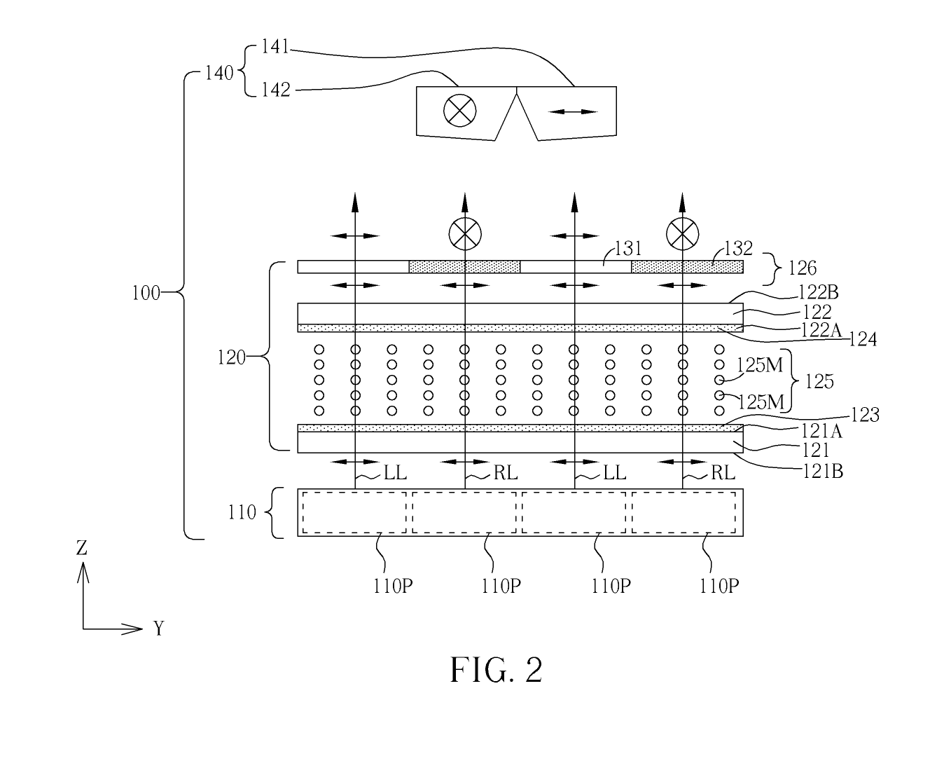

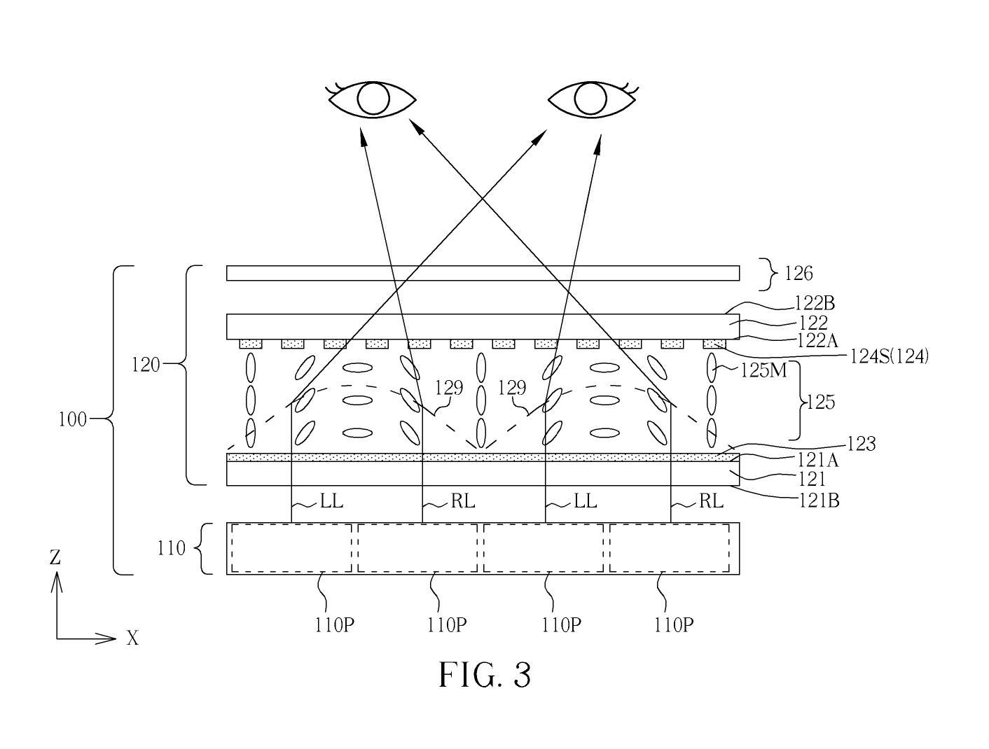

Please refer to FIGS. 1-3. FIG. 1 is a schematic diagram illustrating a naked eye type and glasses type switchable stereoscopic display device according to a first preferred embodiment of the present invention. FIG. 2 is a schematic diagram illustrating a display condition of the naked eye type and glasses type switchable stereoscopic display device in this embodiment under a glasses type stereoscopic display mode. FIG. 3 is a schematic diagram illustrating a display condition of the naked eye type and glasses type switchable stereoscopic display device in this embodiment under a naked eye type stereoscopic display mode. Please note that the figures are only for illustration and the figures may not be to scale. The scale may be further modified according to different design considerations. As shown in FIGS. 1-3, the first preferred embodiment of the present invention provides a naked eye type and glasses type switchable stereoscopic display device 100. The naked eye type and glasses type switchable stereoscopic display device 100 includes a display panel 110 and a switching module 120. The display panel 110 has a display surface 111. The display panel 110 is used to provide first display information LL and second display information RL. The display panel 110 in this embodiment preferably includes a liquid crystal display (LCD) panel, an organic light emitting diode (OLED) display panel, an electro-wetting display panel, an e-ink display panel, a plasma display panel, or a field emitting display (FED) panel, but not limited thereto. The switching module 120 is disposed on a side of the display surface 111 of the display panel 110 to receive the first display information LL and the second display information RL from the display panel 110. The switching module 120 forms a plurality of lenses 129 to change the directions of the first display information LL and the second display information RL under a naked eye type stereoscopic display mode (as shown in FIG. 3). The switching module 120 provides a first phase retardation mode 131 and a second phase retardation mode 132 under the glasses type stereoscopic display mode (as shown in FIG. 2). The first phase retardation mode 131 corresponds to the first display information LL and renders the first display information LL a first polarization state, and the second phase retardation mode 132 corresponds to the second display information RL and renders the second display information RL a second polarization state. The switching module 120 in this embodiment is preferably a liquid crystal panel, and the lenses 129 are preferably liquid crystal lenses, but the present invention is not limited to this. Other appropriate switching modules capable of forming lenses effect and providing phase retardation effects may also be applied in this invention.

As show in FIGS. 1-3, the switching module 120 in this embodiment includes a first transparent substrate 121, a second transparent substrate 122, a first transparent electrode 123, a second transparent electrode 124, and a liquid crystal layer 125. The first transparent substrate 121 has a first inner surface 121A and a first outer surface 121B. The second transparent substrate 122 is disposed oppositely to the first transparent substrate 121. The second transparent substrate 122 has a second inner surface 122A and a second outer surface 122B. The second inner surface 122A faces the first inner surface 121A. The first transparent electrode 123 is disposed between the first transparent substrate 121 and the second transparent substrate 122, and the second transparent electrode 124 is disposed between the first transparent electrode 123 and the second transparent substrate 122. The liquid crystal layer 125 is disposed between the first transparent electrode 123 and the second transparent electrode 124. The liquid crystal layer 125 includes a plurality of liquid crystal molecules 125M. Additionally, the switching module 120 in this embodiment further includes a patterned phase retarding layer 126 disposed on a side of the second outer surface 122B of the second transparent substrate 122. The patterned phase retarding layer 126 is used to provide the first phase retardation mode 131 and the second phase retardation mode 132 so as to render the first display information LL the first polarization state and render the second display information RL the second polarization state. In addition, the display panel 110 in this embodiment may preferably include a plurality of pixel regions 110P, and the pixel regions 110P are preferably arranged along a first direction X and a second direction Y. The first direction X is preferably perpendicular to the second direction Y, but the present invention is not limited to this and the arrangement of the pixel regions 110P may be further modified according to other considerations. Each of the pixel regions 110P in the display panel 110 is used to provide the first display information LL or the second display information RL along a third direction Z. The third direction Z is preferably perpendicular to the display panel 110, but not limited thereto. Each of the pixel regions 110P may include a plurality of sub-pixel regions (not shown) to provide light with different colors or may include only one sub-pixel region to provide a single color according to different design considerations. Additionally, the first display information LL and the second display information RL provided by the display panel 110 preferably are polarized lights. In other words, the display panel 110 preferably includes at least one polarizing film (not shown), but not limited thereto.

As shown in FIG. 2, under the glasses type display mode in this embodiment, the first display information LL, which is designed to be received by a left eye of a viewer, and the second display information RL, which is designed to be received by a right eye of the viewer, are respectively provided by the pixel regions 110P disposed adjacently to each other along the second direction Y synchronously. Under the glasses type display mode, the liquid crystal molecules 125M are not driven, and the polarization states of the first display information LL and the second display information RL will not be changed by the liquid crystal molecules 125M. The first phase retardation mode 131 and the second phase retardation mode 132 are provided by the patterned phase retarding layer 126. The first phase retardation mode 131 corresponds to the first display information LL and renders the first display information LL the first polarization state, and the second phase retardation mode 132 corresponds to the second display information RL and renders the second display information RL the second polarization state. Additionally, the naked eye type and glasses type switchable stereoscopic display device 100 further includes a pair of polarizer glasses 140. The polarizer glasses 140 include a first polarization lens 141 and a second polarization lens 142. The first polarization lens 141 allows a transmission of the first display information LL with the first polarization state and blocks transmission of the second display information RL with the second polarization state, and the second polarization lens 142 allows transmission of the second display information RL with the second polarization state and blocks transmission of the first display information LL with the first polarization state. The viewer wearing the polarizer glasses 140 may accordingly receive the first display information LL and the second display information, which are designed to be combined for the stereoscopic display effect, respectively from the left eye and the right eye, and a glasses type stereoscopic display effect may then be generated. It is worth noting that the first phase retardation mode 131 preferably is a zero wavelength retardation mode, and the second phased retardation mode 132 preferably is a one-half wavelength retardation mode, but the present invention is not limited to this. In other preferred embodiments of the present invention, the first phase retardation mode 131 may be a one-half wavelength retardation mode and the second phased retardation mode 132 ma be a zero wavelength retardation mode according to different considerations. For example, the first display information LL and the second display information RL preferably are polarized in the first polarization state as the first display information LL and the second display information RL are generated from the pixel regions 110P, and the second display information RL is changed to the second polarization state by the second phased retardation mode 132 provided by the patterned phase retarding layer 126. The first polarization state and the second polarization state are preferably orthogonal so as to generate a better image separating effect, but not limited thereto. Additionally, each region of the first phase retardation mode 131 and each region of the second phase retardation mode 132 in the pattern phase retarding layer 126 preferably correspond to each of the pixel regions 110P so as to generate a better stereoscopic display effect.

As shown in FIG. 3, under the naked eye type display mode in this embodiment, the first display information LL, which is designed to be received by the left eye of the viewer, and the second display information RL, which is designed to be received by the right eye of the viewer, are respectively provided by the pixel regions 110P disposed adjacently to each other along the first direction X synchronously. Under the naked eye type display mode, the liquid crystal molecules 125M are driven to form the lenses 129. The direction of the first display information LL and the direction of the second display information RL are respectively modified by the lenses 129. In other words, the first display information LL and the second display information RL are respectively guided toward the left eye and the right eye of the viewer after passing through the lenses 129, and the naked eye type stereoscopic display effect may therefore be generated. More specifically, the second transparent electrode 124 may preferably include a plurality of sub electrode patterns 124S, and each of the sub electrode patterns 124S may preferably include a stripe pattern or a polygonal pattern, but not limited thereto. The liquid crystal molecules 125M corresponding to different sub electrode patterns 124S may be aligned in different conditions by applying different voltage values to each of the sub electrode patterns 124S and applying a common voltage to the first transparent electrode 123. The liquid crystal molecules 125M aligned in different conditions may generate different refractive index effects, and an effect of the lenses 129 may then be formed by modifying a distribution of the different refractive index effects. In this embodiment, the second transparent electrode 124 may preferably include a plurality of sub electrode patterns 124S, and the first transparent electrode 123 preferably is a transparent electrode with a complete surface, but the present invention is not limited to this. In other preferred embodiments of the present invention, a second transparent electrode with a complete surface and a first transparent electrode including a plurality of sub electrode patterns may be combined to form the liquid crystal lens effect, and a second transparent electrode including a plurality of sub electrode patterns may also be combined with a first transparent electrode including a plurality of sub electrode patterns to form the required liquid crystal lens effect. It is worth noting that a variation of the voltage values applied to each of the sub electrode patterns 124S is preferably a gradient variation so as to generate better lenses effects. Additionally, in this embodiment, a birefringence (Δn) of each of the liquid crystal molecules 125M is substantially larger than 0.15 so as to generate better optical performances, but not limited thereto. A forming position of each of the lenses 129 is preferably corresponding to each of the pixel regions 110P so as to generate a better stereoscopic display effect. For example, each of the lenses 129 in this embodiment is disposed correspondingly to two of the pixel regions 110P along the third direction Z, and each of the lenses 129 may be disposed oppositely to two of the pixel regions 110P along the third direction Z, but the present invention is not limited to this. In other preferred embodiments of the present invention, each of the lenses may also be disposed correspondingly to more pixel regions 110P according to other considerations.

The switching module 120 in this embodiment may be used to form the lenses 129 or provide the first phase retardation mode 131 and the second phase retardation mode 132, and the first display information LL and the second display information RL generated from the display panel 110 may be treated to generate the naked eye type stereoscopic display effect and the glasses type stereoscopic display effect. It is worth noting that, in this embodiment, a normal two-dimensional display effect may also be provided by the naked eye type and glasses type switchable stereoscopic display device 100 when the liquid crystal molecules 120M are not driven, and the first display information LL and the second display information RL are not specially modified to be received by the left eye and the right eye of the viewer.

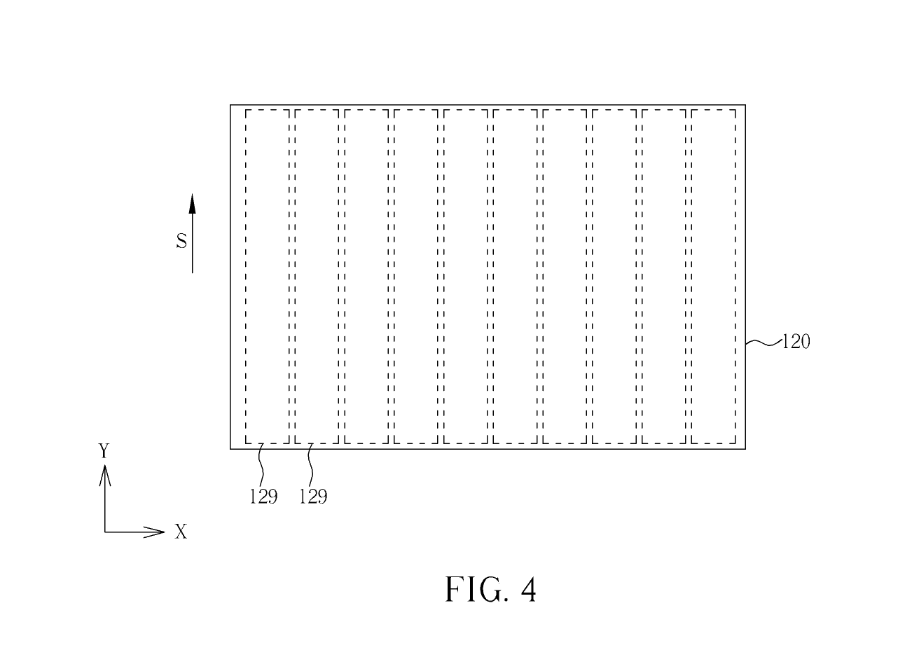

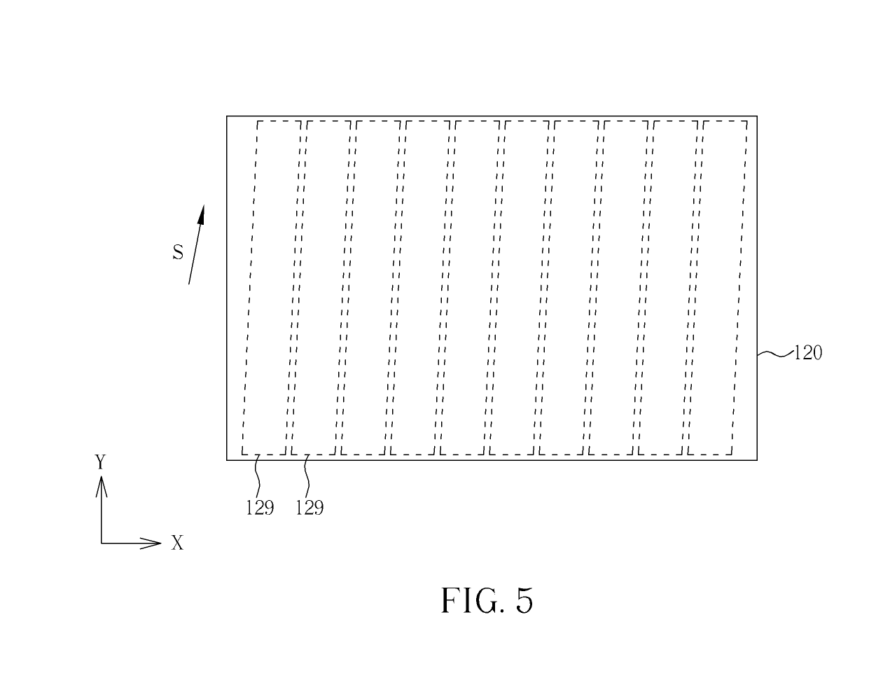

Please refer to FIGS. 3-5. FIG. 4 is a schematic diagram illustrating an arrangement of lenses in the naked eye type and glasses type switchable stereoscopic display device according to the first preferred embodiment of the present invention. FIG. 5 is a schematic diagram illustrating an arrangement of lenses in a naked eye type and glasses type switchable stereoscopic display device according to another preferred embodiment of the present invention. As shown in FIG. 3 and FIG. 4, under the naked eye type stereoscopic display mode in this embodiment, each of the lenses 129 has an extending direction S, and the extending direction S is substantially parallel to the second direction Y so as to match the first display information LL and the second display information RL provided by each of the pixel regions 110P in the display panel 110, but the present invention is not limited to this. As shown in FIG. 5, in another preferred embodiment of the present invention, the extending direction S may also be not parallel to the second direction Y. For example, each of the lenses 129 may be disposed to be tilted with a small angle so as to overcome some optical problems, such as the moiré issue.

The following description will detail the different embodiments of the naked eye type and glasses type switchable stereoscopic display device in the present invention. To simplify the description, identical components in each of the following embodiments are marked with identical symbols. For making it easier to understand the differences between the embodiments, the following description will detail the dissimilarities among different embodiments and the identical features will not be redundantly described.

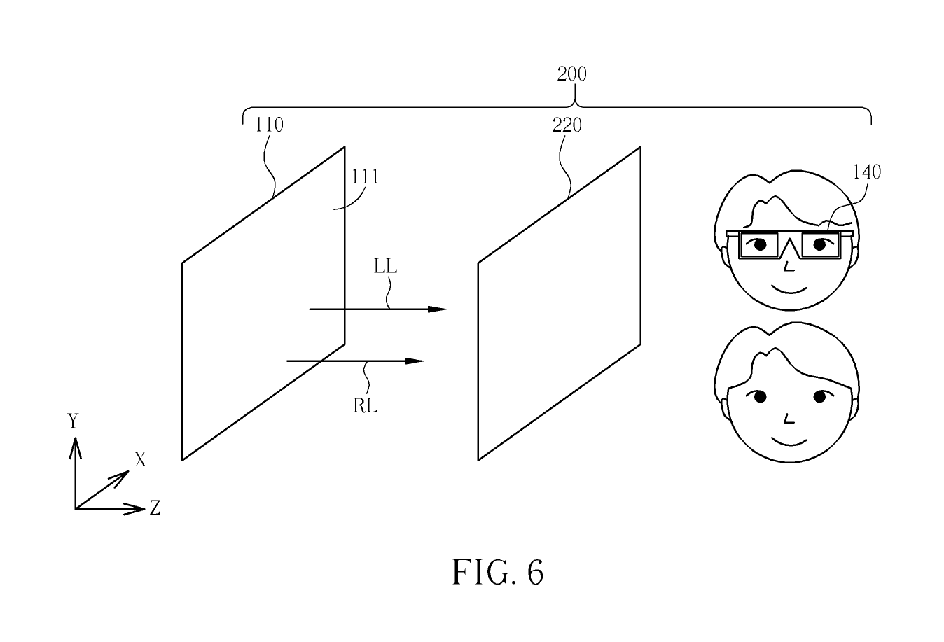

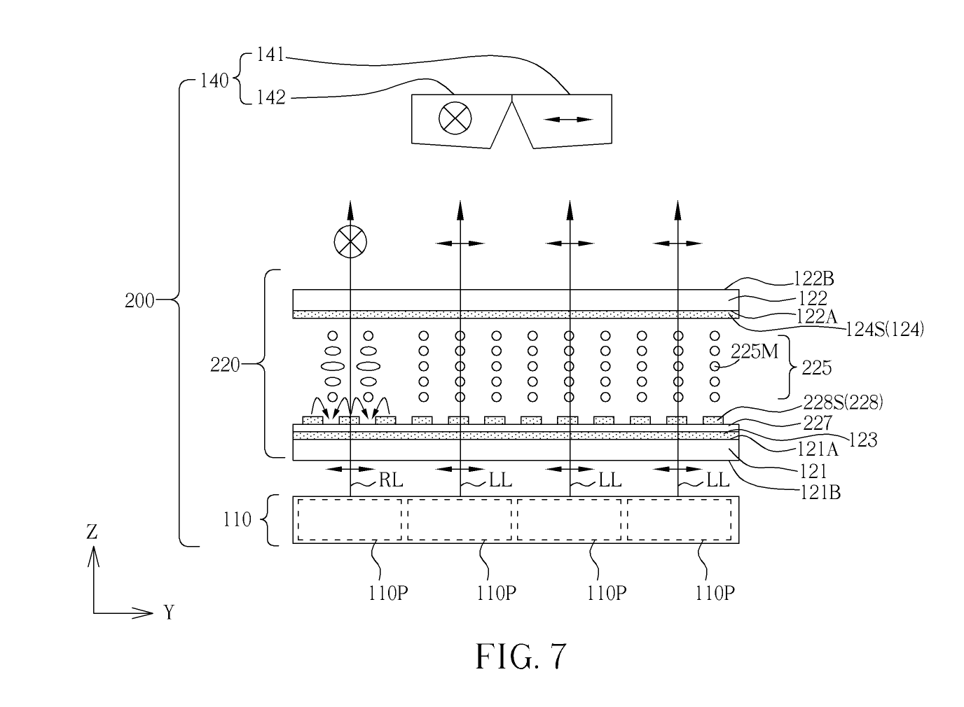

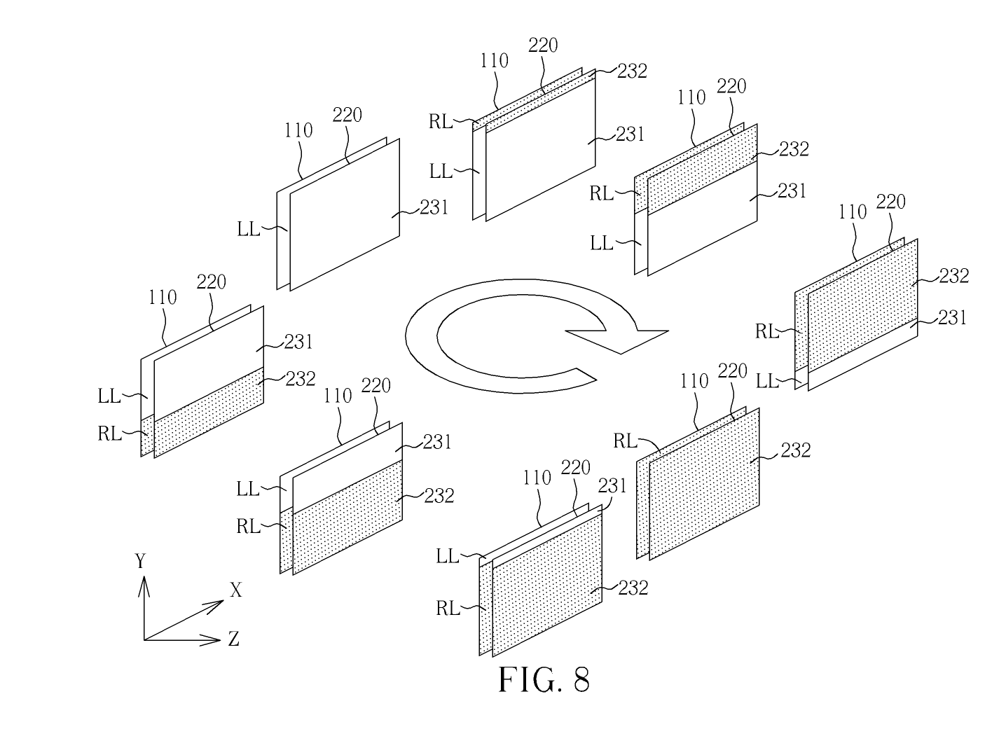

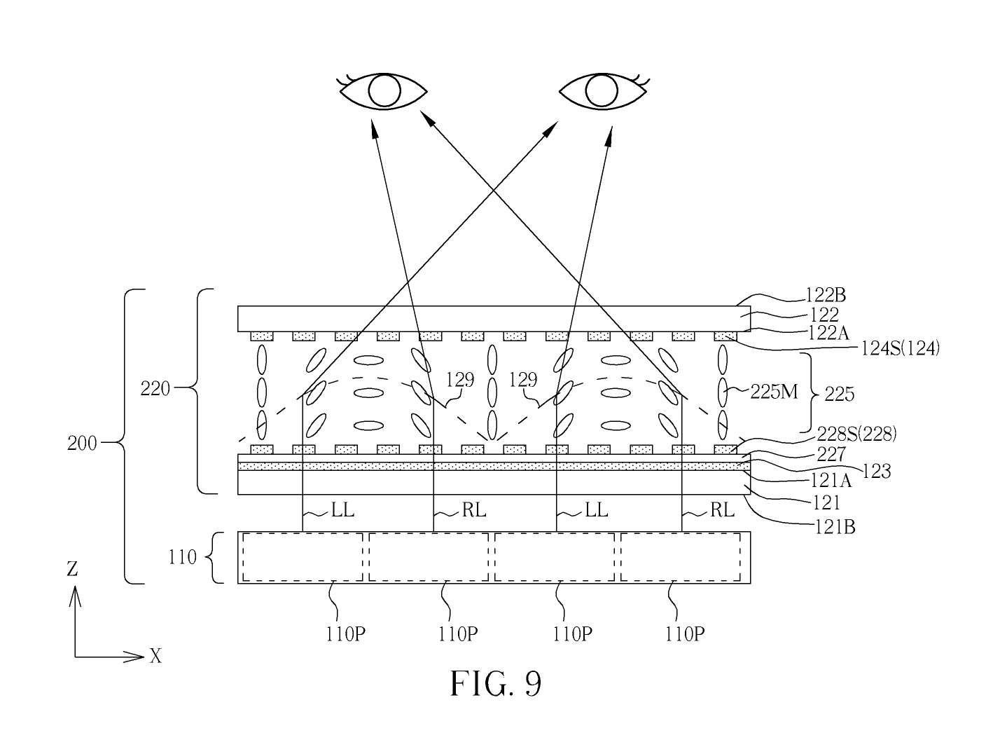

Please refer to FIGS. 6-9. FIG. 6 is a schematic diagrams illustrating a naked eye type and glasses type switchable stereoscopic display device according to a second preferred embodiment of the present invention. FIG. 7 is a schematic diagram illustrating a display condition of the naked eye type and glasses type switchable stereoscopic display device in this embodiment under a glasses type stereoscopic display mode. FIG. 8 is a schematic diagram illustrating an operation of the naked eye type and glasses type switchable stereoscopic display device in this embodiment under the glasses type stereoscopic display mode. FIG. 9 is a schematic diagram illustrating a display condition of the naked eye type and glasses type switchable stereoscopic display device in this embodiment under a naked eye type stereoscopic display mode. As shown in FIG. 6 and FIG. 7, the second preferred embodiment of the present invention provides a naked eye type and glasses type switchable stereoscopic display device 200. The naked eye type and glasses type switchable stereoscopic display device 200 includes a display panel 110 and a switching module 220. The switching module 220 is disposed on a side of the display surface 111 of the display panel 110 to receive the first display information LL and the second display information RL provided by the display panel 110. The difference between the naked eye type and glasses type switchable stereoscopic display device 200 of this embodiment and the naked eye type and glasses type switchable stereoscopic display device 100 of the first preferred embodiment is that the switching module 220 in this embodiment includes a first transparent substrate 121, a second transparent substrate 122, a first transparent electrode 123, a second transparent electrode 124, a third transparent electrode 228, an insulating layer 227, and a liquid crystal layer 225. The insulating layer 227 is disposed between the first transparent electrode 123 and the liquid crystal layer 225, and the third transparent electrode 228 is disposed between the insulating layer 227 and the liquid crystal layer 225. In other words, the liquid crystal layer 225 is disposed between the second transparent electrode 124 and the third transparent electrode 228, and the liquid crystal layer 225 includes a plurality of liquid crystal molecules 225M. Additionally, the second transparent electrode 124 in this embodiment may preferably include a plurality of sub electrode patterns 124S, and the third transparent electrode 228 may preferably include a plurality of sub electrode patterns 228S. Each of the sub electrode patterns 124S and each of the subs electrode patterns 228S may preferably include a stripe pattern or a polygonal pattern, and the first transparent electrode 123 preferably is a transparent electrode with a complete surface, but not limited thereto.

As shown in FIG. 7 and FIG. 8, under the glasses type stereoscopic display mode in this embodiment, the display panel 110 provides the first display information LL and the second display information RL alternately by scanning, and the switching module 220 provides a first phase retardation mode 231 and a second phase retardation mode 232 alternately by scanning synchronously with the display panel 110. The first phase retardation mode 231 corresponds to the first display information LL and renders the first display information LL a first polarization state, and the second phase retardation mode 232 corresponds to the second display information RL and renders the second display information RL a second polarization state. Under the glasses type stereoscopic display mode in this embodiment, the liquid crystal molecules 225M may be driven by controlling an electrical condition between a part of the sub electrode patterns 228S and the first transparent electrode 123, and some of the liquid crystal molecules 225M may then be aligned in a specific manner to provide a phase retardation effect on the light irradiating into the liquid crystal molecules 225M. For example, under the glasses type stereoscopic display mode in this embodiment, the second phase retardation mode 232 is accomplished when the liquid crystal molecules 225M are driven by the corresponding sub electrode patterns 228S of the third transparent electrode 228, and the first phase retardation mode 231 is accomplished when the liquid crystal molecules 225M are not driven by the corresponding sub electrode patterns 228S. In this embodiment, the first phase retardation mode 231 is preferably a zero wavelength retardation mode, and the second phased retardation mode 232 is preferably a one-half wavelength retardation mode, but not limited thereto. It is worth noting that when driving the liquid crystal molecules 225M, the second transparent electrode 124 may be kept in a electrical floating state or a minimal voltage value maybe be applied thereon so as to modify the alignment condition of the liquid crystal molecules 225M, and a required phase retardation effect may be obtained more easily. The method of driving the liquid crystal molecules 225M described above may be regarded as a fringe field switching (FFS) liquid crystal driving approach, but the present invention is not limited to this. In other preferred embodiments of the present invention, other appropriate liquid crystal driving approaches, such as a twisted nematic (TN) liquid crystal driving approach, a in plan switch (IPS) liquid crystal driving approach, a vertical alignment (VA) liquid crystal driving approach, an electrically controlled birefringence (ECB) liquid crystal driving approach, or an optically compensated birefringence (OCB) liquid crystal driving approach, may also be used to generate the required phase retardation effect.

The naked eye type and glasses type switchable stereoscopic display device 200 in this embodiment may further include a phase compensating layer (not shown) disposed on the second outer surface 122B of the second transparent substrate so as to further enhance the display effect. Apart from the scanning approach of providing the first display information LL and the second display information RL by the display panel 110, and the phase retardation effects generated by the liquid crystal molecules 225M under the glasses type stereoscopic display mode in this embodiment, the other components, allocations, material properties, and the principle of separating the first display information LL and the second display information RL in this embodiment are similar to those of the naked eye type and glasses type switchable stereoscopic display device 100 under the glasses type stereoscopic display mode in the first preferred embodiment detailed above and will not be redundantly described. It is worth noting that the first display information LL and the second display information RL are provided alternately by scanning, and the first phase retardation mode 231 and the second phase retardation mode 232 are also provided alternately by scanning synchronously with the display panel 110 (as shown in

FIG. 8). The display images under the glasses type stereoscopic display mode in this embodiment may be accordingly presented in high resolution because the viewer may receive a complete first display information LL and a complete second display information RL respectively at different time points. The resolution of the display image may not be sacrificed for presenting the complete first display information LL and the complete second display information RL at the same time. Additionally, the sub electrode patterns 228S of the third transparent electrode 228 and the region of the corresponding liquid crystal molecules 225M are preferably disposed correspondingly to each of the pixel regions 110P so as to generate a better stereoscopic display effect.

As shown in FIG. 9, under the naked eye type stereoscopic display mode in this embodiment, the first display information LL, which is designed to be received by the left eye of the viewer, and the second display information RL, which is designed to be received by the right eye of the viewer, are respectively provided by the pixel regions 110P disposed adjacently to each other along the first direction X synchronously. Under the naked eye type display mode, the liquid crystal molecules 225M are driven to form a plurality of lenses 129. The direction of the first display information LL and the direction of the second display information RL are respectively changed by the lenses 129, and the first display information LL and the second display information RL are respectively guided toward the left eye and the right eye of the viewer after passing through the lenses 129 so as to generate the naked eye type stereoscopic display effect. The display method, the allocation of the lenses 129, and the principle of separating the first display information LL and the second display information RL under the naked eye type stereoscopic display mode in this embodiment are similar to those of the naked eye type and glasses type switchable stereoscopic display device 100 under the naked eye type stereoscopic display mode in the first preferred embodiment detailed above and will not be redundantly described. It is worth noting that, in this embodiment, the lenses 129 may be formed in the switching module 220 by applying different voltage values to the sub electrode patterns 124S aligned along the first direction X and applying a common voltage to the first transparent electrode 123 and the third transparent electrode 228, but not limited thereto. A variation of the voltage values applied to each of the sub electrode patterns 124S preferably is a gradient variation so as to generate better lenses effects. Additionally, in this embodiment, a birefringence (Δn) of each of the liquid crystal molecules 225M is substantially larger than 0.15 so as to generate better optical performances, but not limited thereto.

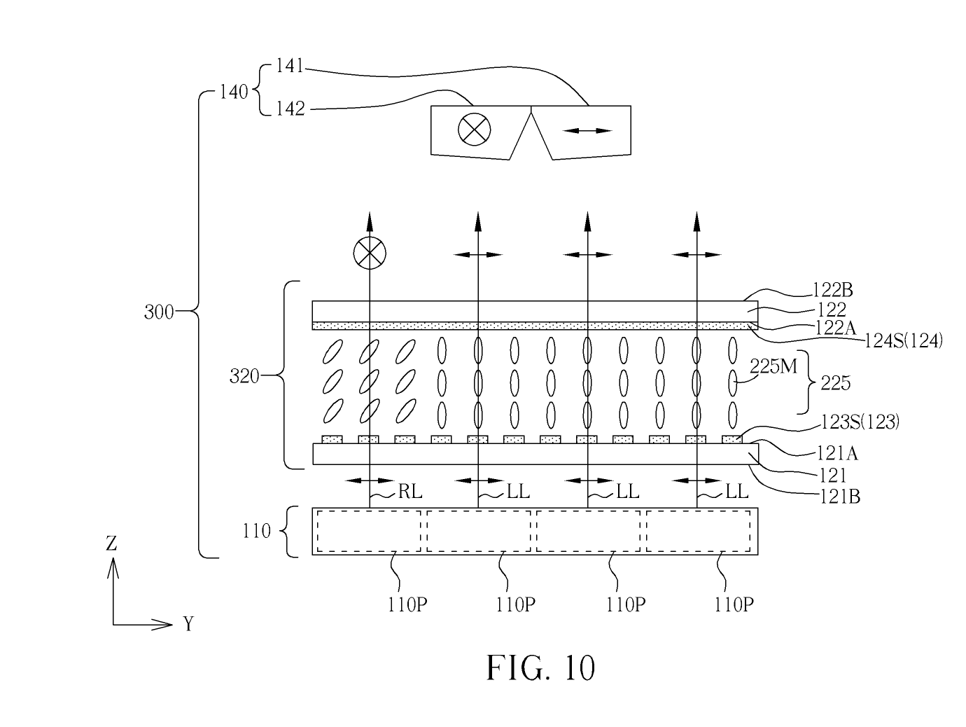

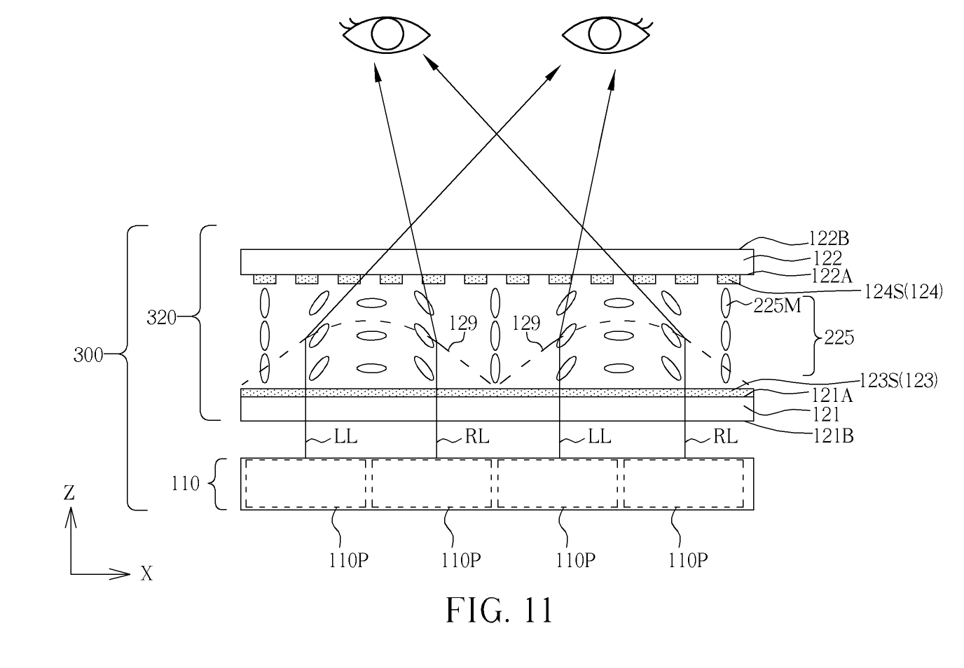

Please refer to FIG. 10 and FIG. 11. FIG. 10 is a schematic diagram illustrating a display condition of the naked eye type and glasses type switchable stereoscopic display device under a glasses type stereoscopic display mode according to a third preferred embodiment of the present invention. FIG. 11 is a schematic diagram illustrating a display condition of the naked eye type and glasses type switchable stereoscopic display device in this embodiment under a naked eye type stereoscopic display mode. As shown in FIG. 10 and FIG. 11, the third preferred embodiment of the present invention provides a naked eye type and glasses type switchable stereoscopic display device 300. The naked eye type and glasses type switchable stereoscopic display device 300 includes a display panel 110 and a switching module 320. The difference between the naked eye type and glasses type switchable stereoscopic display device 300 of this embodiment and the naked eye type and glasses type switchable stereoscopic display device 200 of the second preferred embodiment is that the first transparent electrode 123 in this embodiment includes a plurality of sub electrode patterns 123S, and each of the sub electrode patterns 123S may preferably include a stripe pattern or a polygonal pattern, but not limited thereto. Under the glasses type stereoscopic display mode in this embodiment, the liquid crystal molecules 225M may be driven by controlling an electrical condition between a part of the sub electrode patterns 123S and the second transparent electrode 124, and some of the liquid crystal molecules 225M may then be aligned in a specific manner to provide a phase retardation effect on the light irradiating into the liquid crystal molecules 225M. For example, under the glasses type stereoscopic display mode in this embodiment, the second phase retardation mode (not shown in FIG. 10) is accomplished when the liquid crystal molecules 225M are driven by the second transparent electrode 124 and the corresponding sub electrode patterns 123S of the first transparent electrode 123, and the first phase retardation mode (not shown in FIG. 10) is accomplished when the liquid crystal molecules 225M are not driven by the corresponding sub electrode patterns 123S. The relation between the phase retardation modes and the corresponding display information in this embodiment is similar to the second preferred embodiment described above (as shown in FIG. 8) and will not be redundantly described. It is worth noting that the method of driving the liquid crystal molecules 225M in this embodiment may be regarded as a kind of vertical alignment (VA) liquid crystal driving approach, but limited thereto.

As shown in FIG. 11, under the naked eye type stereoscopic display mode in this embodiment, the lenses 129 may be formed in the switching module 320 by applying different voltage values to the sub electrode patterns 124S aligned along the first direction X and applying a common voltage to the first transparent electrode 123, but not limited thereto. A variation of the voltage values applied to each of the sub electrode patterns 124S is preferably a gradient variation so as to generate better lenses effects. The display method, the allocation of the lenses 129, and the principle of separating the first display information LL and the second display information RL under the naked eye type stereoscopic display mode in this embodiment are similar to those of the naked eye type and glasses type switchable stereoscopic display device 100 under the naked eye type stereoscopic display mode in the first preferred embodiment detailed above and will not be redundantly described.

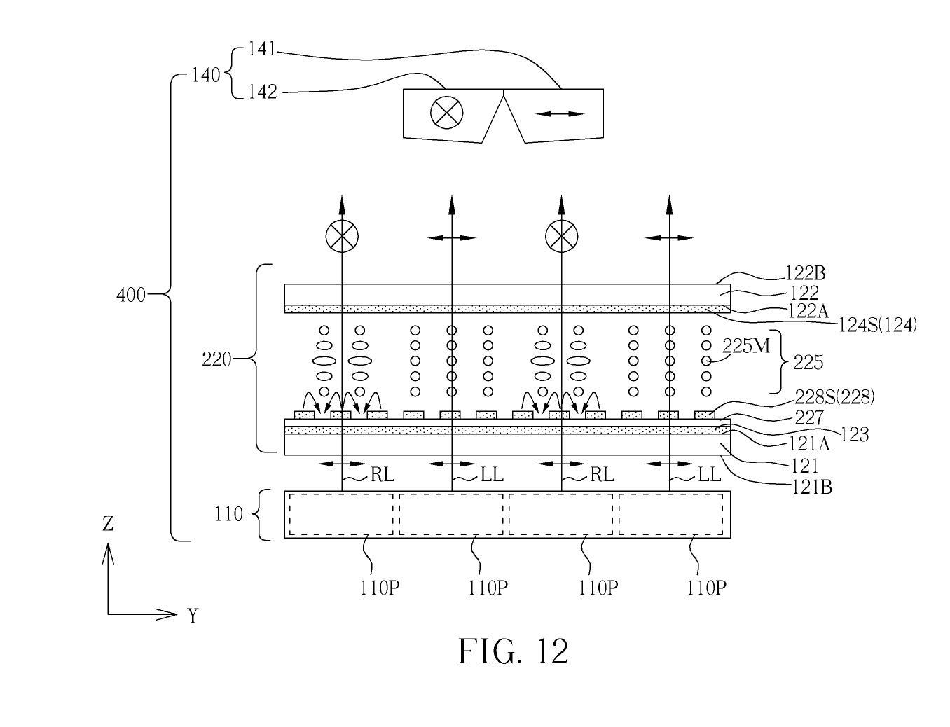

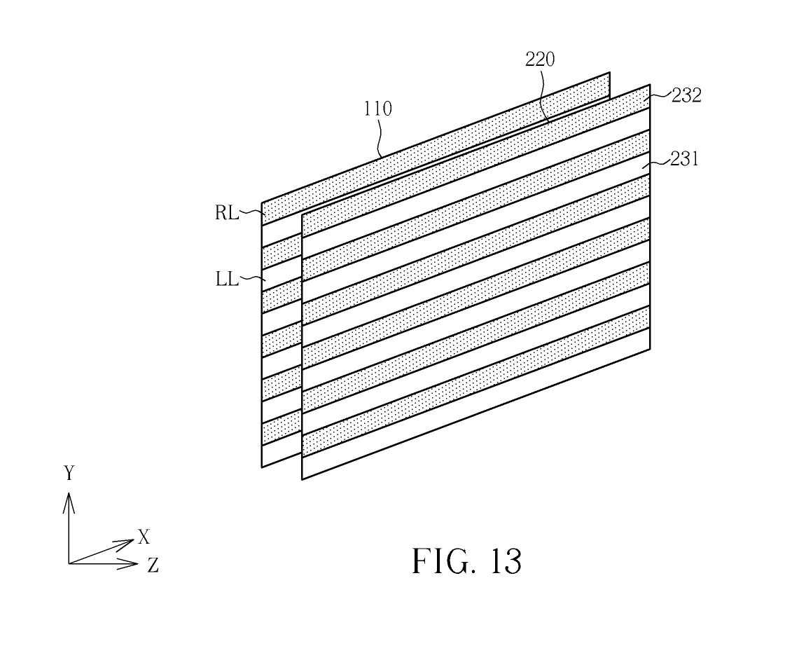

Please refer to FIG. 12 and FIG. 13. FIG. 12 is a schematic diagram illustrating a display condition of the naked eye type and glasses type switchable stereoscopic display device under a glasses type stereoscopic display mode according to a fourth preferred embodiment of the present invention. FIG. 13 is a schematic diagram illustrating an operation of the naked eye type and glasses type switchable stereoscopic display device in this embodiment under the glasses type stereoscopic display mode. As shown in FIG. 12 and FIG. 13, the fourth preferred embodiment of the present invention provides a naked eye type and glasses type switchable stereoscopic display device 400. The naked eye type and glasses type switchable stereoscopic display device 400 includes a display panel 110 and a switching module 220. The difference between the naked eye type and glasses type switchable stereoscopic display device 400 of this embodiment and the naked eye type and glasses type switchable stereoscopic display device 200 of the second preferred embodiment is that, under the glasses type stereoscopic display mode in this embodiment, the display panel 110 provides the first display information LL and the second display information RL simultaneously, and the switching module 220 correspondingly provides the first phase retardation mode 231 and the second phase retardation mode 232 simultaneously. More specifically, the first display information LL, which is designed to be received by a left eye of a viewer, and the second display information RL, which is designed to be received by a right eye of the viewer, are respectively provided by the pixel regions 110P disposed adjacently to each other along the second direction Y synchronously. The switching module 220 simultaneously provides the first phase retardation mode 231 and the second phase retardation mode 232 alternately aligned along the second direction Y. Accordingly, the regions of the first phase retardation mode 231 and the second phase retardation mode 232 in the switching module 220 of this embodiment may be regarded as fixed regions, but not limited thereto. Apart from the method of providing the first display information LL and the second display information RL by the display panel 110 and the method of providing the corresponding first retardation mode 231 and the second retardation mode 232 by the switching module 220 in this embodiment, the structures, components, allocations, material properties, and the principle of separating the first display information LL and the second display information RL in this embodiment are similar to those of the naked eye type and glasses type switchable stereoscopic display device 200 in the second preferred embodiment detailed above and will not be redundantly described. It is worth noting that the method of driving the switching module 220 in this embodiment may be even more simplified because the first retardation mode 231 and the second retardation mode 232 are respectively provided in the fixed regions of the switching module 220, and other related designs may also be accordingly simplified. Additionally, an operation of the naked eye type and glasses type switchable stereoscopic display device 400 under a naked eye type stereoscopic display mode is similar to that of the second preferred embodiment described above and will not be redundantly described. In another preferred embodiment of the present invention, the switching module 220 may only include the first transparent electrode 123 and the second transparent electrode 124, and the liquid crystal molecules 225M may be driven by the first transparent electrode 123 and the second transparent electrode 124 so as to respectively provide the first retardation mode 231 and the second retardation mode 232 in the fixed regions similar to the fourth preferred embodiment of the present invention, but not limited thereto.

To summarize the above descriptions, in the naked eye type and glasses type switchable stereoscopic display device of the present invention, the switching module, which is capable of forming the lenses and providing the phase retardation effects on the light, is disposed in front of the display panel, and the display device may be accordingly switched between the naked eye type stereoscopic display mode, the glasses type stereoscopic display mode, and the normal two-dimensional display mode. The naked eye type and glasses type switchable stereoscopic display device may be switched to the glasses type stereoscopic display mode for high resolutions, and the naked eye type and glasses type switchable stereoscopic display device may be switched to the naked eye type stereoscopic display mode for watching without the glasses. The users with different demands may be satisfied with the multiple display modes provided by the naked eye type and glasses type switchable stereoscopic display device of the present invention.

It is one of the objectives of the present invention to provide a naked eye type and glasses type switchable stereoscopic display device. A switching module, which is capable of forming lenses and providing phase retardation effects on light, is disposed in front of a display panel, and the display device may be accordingly switched between a naked eye type stereoscopic display mode, a glasses type stereoscopic display mode, and a normal two-dimensional display mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A naked eye type and glasses type switchable stereoscopic display device, comprising:
a display panel, having a display surface, wherein the display panel is used to provide first display information and second display information; and
a switching module, disposed on a side of the display surface of the display panel to receive the first display information and the second display information from the display panel, wherein the switching module forms a plurality of lenses to change directions of the first display information and the second display information under a naked eye type stereoscopic display mode, and the switching module provides a first phase retardation mode and a second phase retardation mode under a glasses type stereoscopic display mode, wherein the first phase retardation mode corresponds to the first display information and renders the first display information a first polarization state, and the second phase retardation mode corresponds to the second display information and renders the second display information a second polarization state.

2. The naked eye type and glasses type switchable stereoscopic display device of claim 1, wherein the switching module comprises a liquid crystal panel.

3. The naked eye type and glasses type switchable stereoscopic display device of claim 1, wherein the first phase retardation mode comprises a zero wavelength retardation mode, and the second phased retardation mode comprises a one-half wavelength retardation mode.

4. The naked eye type and glasses type switchable stereoscopic display device of claim 1, further comprising a pair of polarizer glasses which includes a first polarization lens and a second polarization lens, wherein under the glasses type stereoscopic display mode, the first polarization lens allows transmission of the first display information in the first polarization state and blocks transmission of the second display information in the second polarization state, and the second polarization lens allows transmission of the second display information in the second polarization state and blocks transmission of the first display information in the first polarization state.

5. The naked eye type and glasses type switchable stereoscopic display device of claim 2, wherein the switching module comprises:
a first transparent substrate, having a first inner surface and a first outer surface;
a second transparent substrate, disposed oppositely to the first transparent substrate, wherein the second transparent substrate has a second inner surface and a second outer surface, and the second inner surface faces the first inner surface;
a first transparent electrode, disposed between the first transparent substrate and the second transparent substrate;
a second transparent electrode, disposed between the first transparent electrode and the second transparent substrate; and
a liquid crystal layer, disposed between the first transparent electrode and the second transparent electrode, wherein the liquid crystal layer comprises a plurality of liquid crystal molecules.

6. The naked eye type and glasses type switchable stereoscopic display device of claim 5, wherein the switching module further comprises a patterned phase retarding layer disposed on a side of the second outer surface of the second transparent substrate, and the patterned phase retarding layer is used to renders the first display information the first polarization state and renders the second display information the second polarization state.

7. The naked eye type and glasses type switchable stereoscopic display device of claim 5, wherein the display panel comprises a plurality of pixel regions, and the pixel regions are arranged along a first direction and a second direction.

8. The naked eye type and glasses type switchable stereoscopic display device of claim 7, wherein under the naked eye type stereoscopic display mode, each of the lenses has an extending direction, and the extending direction is substantially parallel to the second direction.

9. The naked eye type and glasses type switchable stereoscopic display device of claim 7, wherein under the naked eye type stereoscopic display mode, each of the lenses has an extending direction, and the extending direction is not parallel to the second direction.

10. The naked eye type and glasses type switchable stereoscopic display device of claim 5, wherein the switching module further comprises an insulating layer and a third transparent electrode, the insulating layer is disposed between the first transparent electrode and the liquid crystal layer, and the third transparent electrode is disposed between the insulating layer and the liquid crystal layer.

11. The naked eye type and glasses type switchable stereoscopic display device of claim 10, wherein the third transparent electrode comprises a plurality of sub electrode patterns, and under the glasses type stereoscopic display mode, the second phase retardation mode is accomplished when the liquid crystal molecules are driven by the corresponding sub electrode patterns, and the first phase retardation mode is accomplished when the liquid crystal molecules are not driven by the corresponding sub electrode patterns.

12. The naked eye type and glasses type switchable stereoscopic display device of claim 5, wherein a birefringence (Δn) of each of the liquid crystal molecules is substantially larger than 0.15.

13. The naked eye type and glasses type switchable stereoscopic display device of claim 1, wherein under the glasses type stereoscopic display mode, the display panel provides the first display information and the second display information alternately by scanning, and the switching module provides the first phase retardation mode and the second phase retardation mode alternately by scanning synchronously with the display panel.

14. The naked eye type and glasses type switchable stereoscopic display device of claim 1, wherein under the glasses type stereoscopic display mode, the display panel provides the first display information and the second display information simultaneously, and the switching module correspondingly provides the first phase retardation mode and the second phase retardation mode simultaneously.

15. The naked eye type and glasses type switchable stereoscopic display device of claim 1, wherein the display panel comprises a liquid crystal display (LCD) panel, an organic light emitting diode (OLED) display panel, an electro-wetting display panel, an e-ink display panel, a plasma display panel, or a field emitting display (FED) panel.
